(19) United States
(12) Patent Application Publication
(10) Pub. No.: US 2015/0381614 A1
(43) Pub. Date: Dec. 31, 2015

(54) METHOD AND APPARATUS FOR UTILIZING BIOMETRICS FOR CONTENT SHARING

(71) Applicant: Qualcomm Incorporated, San Diego, CA (US)

(72) Inventors: Evan Robert Hildreth, Thornhill (CA); Jonathan Karl Kies, Encinitas, CA (US); Robert Scott Tartz, San Marcos, CA (US); Joel Simbulan Bernarte, San Diego, CA (US); Xin Zhong, San Diego, CA (US); Virginia Walker Keating, San Diego, CA (US)

(21) Appl. No.: 14/314,284

(22) Filed: Jun. 25, 2014

(51) Int. Cl. H04L 29/06; H04W 12/06; G06F 21/60; G06F 21/32

(52) U.S. Cl. CPC H04L 63/0861; G06F 21/32; H04W 12/06; H04L 63/0884; G06F 21/60

(57) ABSTRACT

Disclosed is a method and apparatus for biometric based media data sharing. The method may include initiating, in a first device, biometric data capture of a user based, at least in part, on playback of media data by the first device. The method may also include determining that captured biometric data of the user does not correspond with biometric data associated with an authorized user of the first device. Furthermore, the method may also include in response to a failure to match the captured biometric data by the first device, establishing that the user is an authorized user of a second device based, at least in part, on the captured biometric data. The method may also include sharing the media data with the second device.

### FIELD

The subject matter disclosed herein relates generally to sharing media data between devices.

### BACKGROUND

Media devices are pervasive in today's society. Users create, store, access, and run applications to view videos, listen to music, participate in live streaming, etc. Oftentimes, a user may wish to share media content from one device to another, such as amusing content on the internet and pictures and videos that a user creates with a device. To share the media content, the user can send this content to a friend via email, messaging, social networks, or other means. It is also common that a user will hand a device to a friend or hold the device so that the friend can view the content. After viewing the content, the friend will often want that content on their own device, and must request that the content be emailed, messaged, or sent via a social network at a later time by the device owner. This process can be cumbersome, which can lead to the failure to share desired content.

### BRIEF DESCRIPTION OF THE DRAWINGS

FIG. 1 is a flow diagram of one embodiment of a method for content sharing utilizing user biometric data;

FIG. 2 is block diagram of one embodiment of a user device, a media device, and a verification server that implement content sharing based on user biometric data according to the embodiments described herein;

FIG. 3 is a flow diagram of one embodiment of a method for biometric capture for content sharing;

FIG. 4 is a flow diagram of one embodiment of a method for locating a device based on user biometric data and exchanging content with the located device;

FIG. 5 is a flow diagram of one embodiment of a method for utilizing a verification server for exchanging content between devices based on user biometric data;

FIG. 6 is one embodiment of a computer system that may be used as a verification server; and

FIG. 7 is one embodiment of a mobile device that may be used for a media device or a user device.

### DETAILED DESCRIPTION

The embodiments discussed here relate to systems and methods that utilize biometric data capture to initiate and facilitate the sharing of content. The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

In one embodiment, when media data content is viewed, listened to, or otherwise consumed by a user on a first device, such as a mobile device, tablet computer, desktop computer, digital television, etc., the first device captures biometric data associated with the consumer of the media data content and performs biometric identification. For example, the device captures user biometric data for performing one or more of facial pattern detection and recognition, fingerprint scanning, grip pattern detection, voice recognition, iris scanning, sclera scanning, electrocardiogram recognition, vascular pattern recognition, touch pattern recognition, etc. From the captured biometric data, the first device extracts the appropriate biometric feature data from the captured biometric data and generates a biometric template or feature vector.

In one embodiment, the first device utilizes the extracted biometric feature data to determine if the biometric data is associated with an authorized user of the device, such as a device owner, a person or group of people with permission to use the device, etc., an authorized consumer of the content, or both. The first device may store one or more biometric templates for the authorized users, and in response to the biometric data capture attempts to match the user's biometric data against the stored biometric template data. When the biometric data does not match an authorized user of the first device (i.e., the content consumer is not associated with the device and/or content), the first device detects one or more nearby devices, such as a second device. Detection of the nearby device involves searching for the first device from among zero or more nearby devices using one or more location techniques. For example, the detection of nearby devices can involve locating devices connected to the same WiFi network as the first device, locating devices on the same network as the first device and which are within a geofenced boundary, locating devices using Bluetooth communication protocols (i.e., devise within range of a Bluetooth network), locating devices on a personal area network, etc.

The extracted biometric feature data of the content consumer may then be exchanged with the second, nearby device. The second device utilizes the received biometric feature data to determine if the content consumer is a user of the second device and/or an authorized user of the content. In particular, the second device utilizes biometric data previously captured by the second device for matching against the received biometric data. When a match is found, the content may be transferred to the second device. The transfer of content may include one or more of transferring the actual content, transferring instructions to the matched nearby device to enable the nearby device to obtain the content, transferring a link to the content, transferring digital media rights associated with the content, etc. In one embodiment, and as discussed in greater detail below, rather than exchanging biometric data directly with the nearby device, the first device may send the biometric data to a verification server to determine if the biometric data is associated with the nearby device, and/or to facilitate the exchange of shared media data. Furthermore, the content, link, instructions, rights, etc. may also be transferred to an account, such as a digital media account maintained at the verification server or other server, for later consumption by the user.

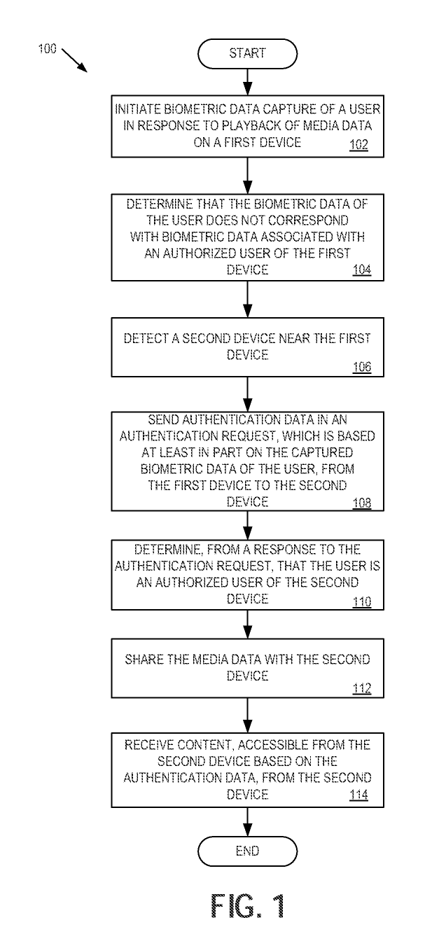

FIG. 1 is a flow diagram of one embodiment of a method 100 for content sharing utilizing user biometric data. The method 100 is performed by processing logic that may comprise hardware (circuitry, dedicated logic, etc.), software (such as is run on a general purpose computer system or a dedicated machine), firmware, or a combination.

Referring to FIG. 1, processing logic begins by initiating biometric data capture of a user in response to playback of media data on a first device (processing block 102). In one embodiment, the first device is a device capable of reproducing audio, visual, or audiovisual data, such as a mobile telephone, music player, tablet computer, desktop computer, digital television, etc. In one embodiment, the biometric data capture is initiated each time the first device plays media data. However, the biometric data capture may also be initiated in response to events such as upon detecting a voice command in conjunction with the playback of media data, detecting a user interface command or selection by a user during playback of the media data, upon an inferred action, such as detection of a user speaking “this is cool” or detecting laughter, during playback of the media data, detecting a gesture, such as motion data indicative of a handoff of the first device, during playback of the media data, etc. Furthermore, biometric data may be captured for multiple users viewing the content. In one embodiment, the capture of biometric data from the multiple users may occur during playback of the media data and for a defined period of time after playback, such as 1 hour, 10 minutes, etc., and/or may encompass a defined location relative to the first device, such as capture within a geofenced boundary, capture within a physical structure, etc.

Processing logic determines that the biometric data of the user does not correspond with biometric data associated with an authorized user of the first device, and thus a biometric mismatch has occurred (processing block 104). In one embodiment, an authorized user may be an owner of a device, or a user with one or more permissions to access the device. The authorized users' biometric data may be pre-registered with the first device, and utilized for matching with the captured biometric data using one or more biometric matching processes. In one embodiment, authorized users of a device can include a device owner, such as a parent, and additional user(s) with permissions to access the device, such as the parent's children. As another example, a device owner may be a corporation, and a group of employees may have permissions to access the device. Furthermore, when there are multiple consumers of the media data, the biometric mismatch of more than one user may be determined by processing logic at processing block 104.

Processing logic then detects a second device near the first device (processing block 106). In one embodiment, processing logic performs the biometric matching processes, and utilizes the determination of a biometric mismatch, such as detecting that the captured biometric data does not match an owner or any authorized user of the device, to initiate the data sharing process with a nearby device. In one embodiment, nearby devices are detected by locating devices connected to the same WiFi network, devices within a geofenced boundary, devices within range of a personal area network established by the first device, collocated devices, etc. In one embodiment, multiple nearby devices can be detected which correspond to one or more of a plurality of users who's biometric data was captured at processing block 102.

Processing logic then sends authentication data, which is based at least in part on the captured biometric data of the user, from the first device to the second device in an authentication request (processing block 108). In one embodiment, the extracted biometric feature data may be sent from the first device to the second device, as well as to other nearby devices. In another embodiment, a hash value may be computed from the extracted biometric feature data, and the hash value sent to the second device as the authentication data in an authentication request. In yet another embodiment, a challenge-response process may be utilized with the second device, where the challenge is based at least in part captured biometric data. In yet another embodiment, one or more second devices near the first device may request user verification that they are consuming the media data at the first device as a condition to the exchange of media data. Furthermore, as discussed in greater detail below, these techniques may be utilized with a verification server, which serves as an authentication and/or communication intermediary between the first and second devices.

Processing logic determines, from a response to the authentication request, that the user is an authorized user of the second device (processing block 110). As discussed above, the determination can be based on results of the second device matching received biometric feature data to a template of biometric data of an authorized user of the second device, based on results of a challenge-response process that is based at least in part on the biometric data, based on a successful verification or recreation of the hash function applied to the biometric data, determination that a user has accepted a prompt to verify their identity, etc.

Processing logic then shares the media data with the second device (processing block 112). In one embodiment, the media data itself is transferred from the first device to the second via email, messaging, file transfer, etc. In another embodiment, the first device transfers a link, instructions, rights, etc. to the second device to instruct and enable the second device how to access the media data. In one embodiment, mentioned above and discussed in greater detail below, a verification server may act as an intermediary by receiving the shared content and/or instructions from the first device, and transferring them to the second device. Furthermore, where multiple users' biometric data is captured and where multiple matches are found with nearby devices, an ad hoc network of media content viewers may be formed between the plurality of devices for exchanging content. In one embodiment, this ad hoc network may be maintained for a predetermined maximum period of time that the ad hoc network can be active, as well during a time when each nearby device remains within a boundary or distance limit relative to the first device and/or other members of the ad hoc network.

Processing logic may also receive content, accessible from the second device based on the authentication data, from the second device (processing block 114). In one embodiment, after authentication of the user as an authorized user of the second device from the exchange of biometric data, as discussed herein, the second device may provide content to the first device. In one embodiment, the content provided to the first device may be protected content, such as content accessible by the user from the second device, and which is accessible only after the user has provided access credentials for the content. For example, a user may desire to view videos from a favorites list on a media streaming service on the first device, but does not want to provide their login details to the media streaming service to the first device due to a lack of trust associated with the first device. In one embodiment, after the nearby device associated with the user is located, and the user is authenticated to the second device via the biometric data, the user may utilize the first device as a proxy to the protected content. In one embodiment, the user may request their favorites list at the first device, and the first device transmits the request to the second device. The second device uses the captured biometric data, or a prior biometric authentication, of the user to access the requested protected content. The protected content can then be provided to the first device, without the user sharing login credentials for the requested protected content. As a result, the user's access credentials to the protected content remain protected from the first device, while still being able to access their protected content on the first (potentially untrusted) device.

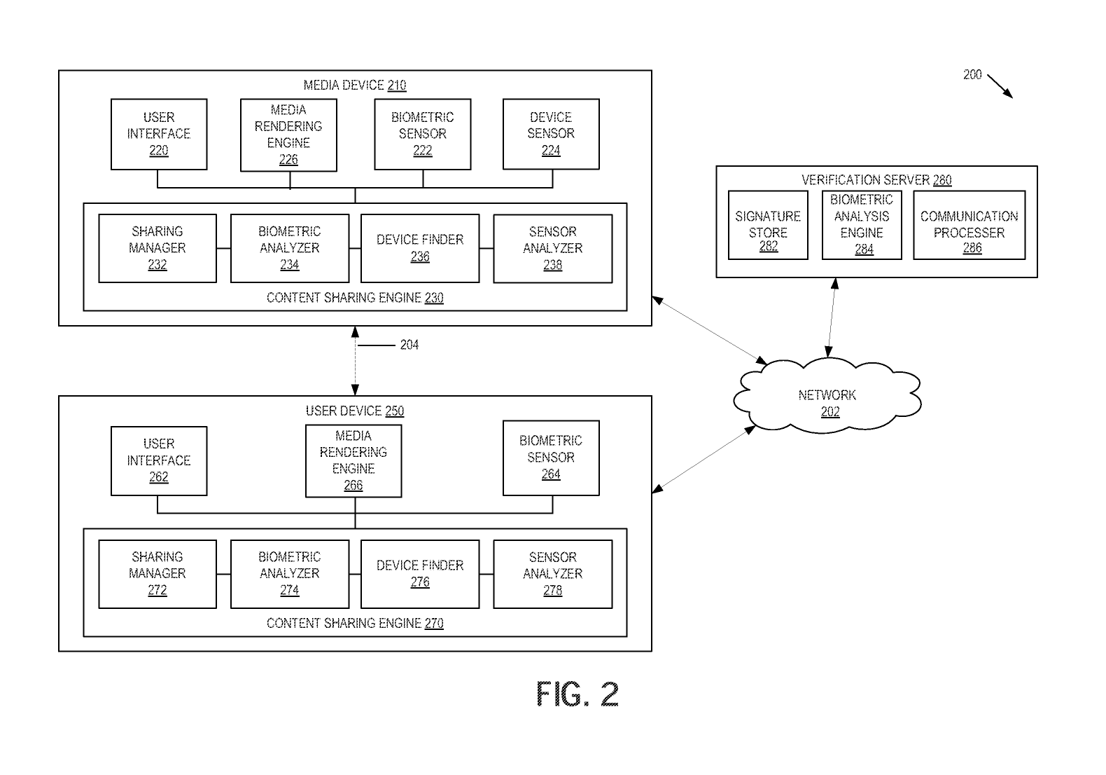

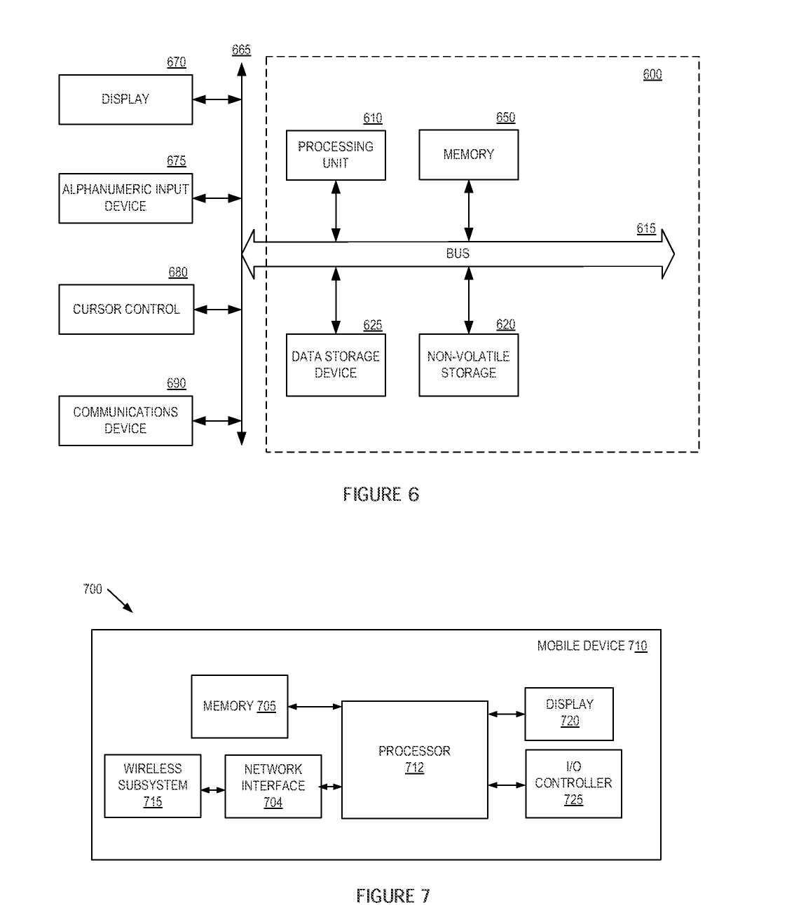

FIG. 2 is block diagram of one embodiment 200 of a media device 210, user device 250, and verification server 280 that implement content sharing based on user biometric data according to the embodiments described herein. In one embodiment, media device 210, user device 250, and verification server 280 are systems, which may include one or more processors, memory, I/O controllers, network interfaces, displays, etc. FIGS. 6 and 7, discussed below, provide additional details for the systems illustrated in FIG. 2.

In one embodiment, media device 210 and user device 250 are each an electronic device, such as a mobile telephone, tablet computer, television, etc., which are capable of playback of audio, video, or audiovisual data. In one embodiment, media device 210 includes a content sharing engine 230, a user interface 220, a media rendering engine 226, a biometric sensor 222, and one or more device sensors 224. User device 250 also includes a content sharing engine 270, user interface 262, media rendering engine 266, and biometric sensor 264. In one embodiment, media device 210 and user device 250 may utilize the services of verification server 280, which includes a signature store 282, biometric analysis engine 284, and communication processor 286.

In one embodiment, media device 210 and user device 250 may be communicatively coupled with one another via a wireless link 204. In one embodiment, wireless link may be utilized to establish a personal area network, such as a WiFi, Zigbee, ANT, Bluetooth, Visible Light Communication (VLC), etc. network. In one embodiment, one or more of media device 210, user device 250, and verification server 280 may also be coupled to a network 202 and communicate with one another using any of the standard protocols for the exchange of information. In one embodiment, when media device 210 and/or user device 250 is a mobile computing device or mobile communication device, the media device 210 and/or user device 250 may be coupled with network 202 via a wireless connection, such as a cellular telephone connection, wireless fidelity connection, etc.

In one embodiment, the media device 210 and user device 250, and verification server 280, may run on one Local Area Network (LAN) and may be incorporated into the same physical or logical system, or different physical or logical systems. Alternatively, the media device 210 and user device 250, and verification server 280, may reside on different LANs, wide area networks, cellular telephone networks, etc. that may be coupled together via the Internet but separated by firewalls, routers, and/or other network devices. In yet another configuration, the media device 210 and user device 250, and verification server 280, may reside on the same server, or different servers, coupled to other devices via a public network (e.g., the Internet) or a private network (e.g., LAN). It should be noted that various other network configurations can be used including, for example, hosted configurations, distributed configurations, centralized configurations, etc.

In one embodiment, media device 210 may be utilized to render media data, such as audio data, visual data, or audiovisual data, to one or more users with the user interface 220. In one embodiment, sharing manager 232 of the content sharing engine 230 detects the playback of the media data and initiates a biometric based sharing process. In one embodiment, the sharing process is initiated by sharing manager 232 in response to the playback of the media data. In another embodiment, the sharing process is initiated by sharing manager 232 in response to detection of one or more additional conditions. In one embodiment, device sensor 224 may capture motion data for analysis by sensor analyzer 238 indicative of physical movement of the media device 210, such as movement data indicative of media device 210 being handed to a user when playback of a video begins. Device sensor 224 may capture additional data for analysis by sensor analyzer 238, such as voice commands to “send this video to my phone”, voice data indicative of an inferred command such as “this video is cool” or laughing, etc. Sharing manager 232 may also receive an explicit command from the user interface 220, such a user selection of a “like” button, “transfer” button, etc.

In response to the playback of the media data, and optionally one or more of the conditions discussed above, sharing manager 232 causes biometric sensor 222 to capture user biometric data associated with one or more users consuming the media data. In one embodiment, the biometric sensor 222 may include multiple sensors that capture one or more types of biometric data, such as image data of one or more faces, user fingerprint scans, a user's grip pattern, audio data associated with a voice command of one or more users, scans of a user's iris, scans of a user's sclera, capture of electrocardiogram data, capture of vascular pattern data, touch pattern data, etc.

The captured biometric data is provided to biometric analyzer 234 to perform one or more biometric matching processes. In one embodiment, sharing manager 232 registers and stores biometric data as one or more feature vectors and/or biometric templates for authorized users of the media device 210. Biometric analyzer 234 attempts to match the captured biometric data against the registered/stored biometric data. When there is a match, biometric analyzer 234 informs sharing manager 232 that the media content consumer is an authorized user, and a sharing process is not initiated. However, when there is a biometric mismatch, and the captured biometric data is not associated with any authorized user of the media device 210, sharing manager 232 informs device finder 236 to locate one or more nearby devices in an attempt to establish a biometric match with a nearby device.

In one embodiment, device finder 236 attempts to locate nearby devices that are connected to the same WiFi or LAN network, such as network 202, as the media device. In one embodiment, the devices are determined to be nearby when they are within a geofenced boundary based on location data associated with the media device 210. In another embodiment, device finder 236 attempts to locate and establish a personal area network connection with nearby devices. In this embodiment, device finder 236 can utilize Bluetooth beacons, or other personal area network protocols, such as WiFi, Zigbee, ANT, VLC, etc., to locate devices in range of the media device 210. In one embodiment, when a nearby device, such as user device 250, is within range to connect to the personal area network, a wireless communication link 204 is established between the device finder 236 of media device 210 and the device finder 276 of user device 250.

In one embodiment, sharing manager 232 sends the mismatched biometric data to the content sharing engine 270 of the user device 250. In one embodiment, the biometric data may be encrypted prior to transfer. In another embodiment, a hash value may be calculated from the biometric data, feature vector, or template, and the hash value transferred to the user device 250. Biometric analyzer 274 of user device 250 then attempts to match the received biometric data with the biometric data captured from authorized users of the user device 250. When biometric analyzer 274 determines that the received biometric data matches an authorized user's biometric data, user device 250 informs media device 210 of the match to enable media device 210 to establish the biometric match.

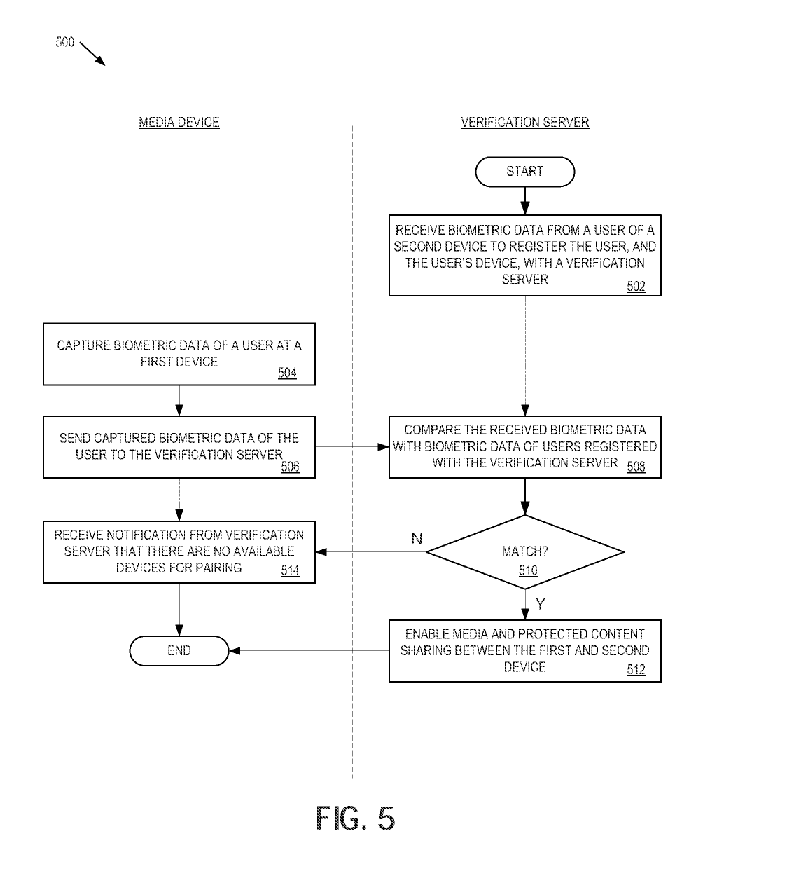

In one embodiment, rather than sending the mismatched biometric data to the user device 250, media device 210 may transfer the biometric data to verification server 280. In one embodiment, as discussed in greater detail below in FIG. 5, verification server 280 utilizes a biometric analysis engine 284 to compare the received biometric data with registered user biometric data stored by verification server 280 in a signature store 282. The signature store 282 stores preregistered user biometric data, which is associated with one or more user devices and/or device identifiers. When biometric analysis engine 284 determines that the biometric data matches registered biometric data, verification server 280 sends the device and/or user identification corresponding to the matched biometrics to media device 210.

Once content sharing engine 230 receives notice of a biometric match with the user device 250 (either from user device 250, or from verification server 280, or both), sharing manager 232 sends the media data via wireless link 204 to the sharing manager 272 of the user device 250. In one embodiment, the sharing manager 272 may display a prompt to a user via user interface 262 to request the user's consent to receive the transfer of the media data. Furthermore, the media content itself can be transmitted to user device 250, or data that enables user device 250 to obtain the media data, such as links, URLs, instructions, etc., is transmitted to user device 250. A user may then request and play back the shared content on the user device 250 via user interface 262.

In one embodiment, verification server 280 may again be utilized by media device 210 to handle the transfer of the media data. In this embodiment, the media data, link, instructions, URL, etc. is transferred to communication processer 286 of verification server 280. Communication processer 286 informs content sharing engine 270 of user device 250 of the availability of the shared content. Then, a user could request the shared content to be downloaded to the user device 250, either from the verification server 280 or using one or more the URL, link or media access instructions provided by media device to verification server 280. The user device 250 can thereafter access and render the shared content via user interface 262.

In one embodiment, after a biometric match has been established with user device 250, content sharing engine 230 may store the captured biometric data along with the device identification for user device 250. In one embodiment, the biometric data is cached for later biometric-based content sharing. In one embodiment, to avoid maintaining sensitive user data, such as a user's complete biometric signature, content sharing engine 230 computes a hash value of the biometric data, and retains the hash value instead of the captured biometric data. In this embodiment, later captured biometric data can be hashed and compared to the stored/cached hash values. When a matching biometric hash value is found, the corresponding device identifier can be utilized by content sharing engine 230 to accelerate the subsequent biometric based sharing process, as discussed herein.

Furthermore, in one embodiment, after a biometric match has been found with user device 250, user device 250 may serve as a proxy for protected data access on the media device 210. In one embodiment, the matched user (i.e., authorized user of device 250) may request, via user interface 220 of the media device 210, access to protected content. In order to avoid the user providing sensitive information, such as usernames, passwords, or other authentication data for accessing the protected content, user interface 220 sends the request to content sharing engine 270. In one embodiment, sharing manager 272 utilizes the prior biometric match as an authentication of the user, and uses the user's access credentials to access the requested protected content. The request protected content may then be transferred from user device 250 to media device 210. Media device 210 is then able to render the protected content via user interface 220.

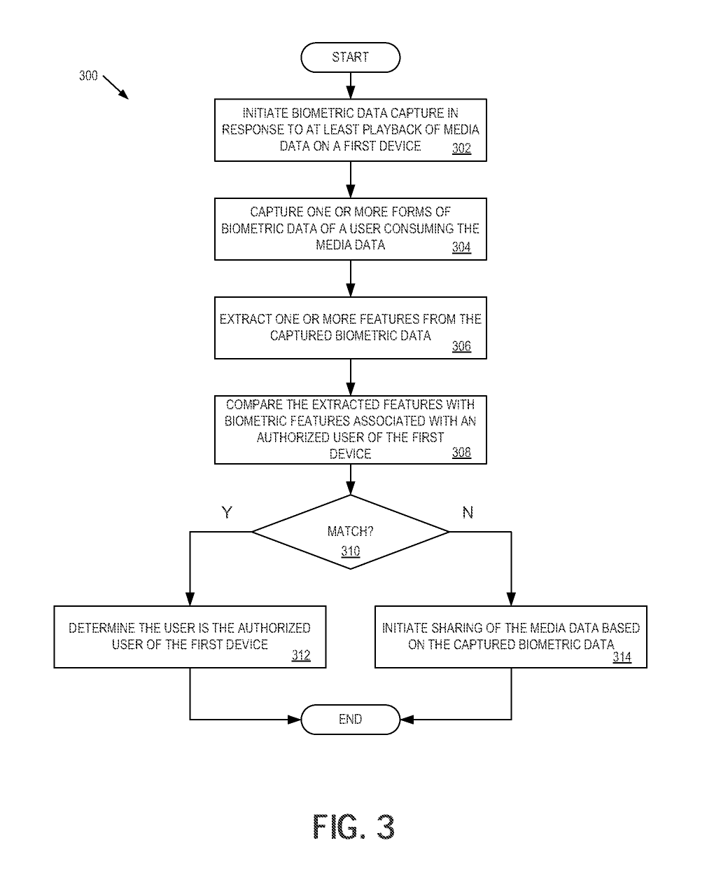

FIG. 3 is a flow diagram of one embodiment of a method 300 for biometric capture for content sharing. The method 300 is performed by processing logic (not illustrated in FIG. 3) that may comprise hardware (circuitry, dedicated logic, etc.), software (such as is run on a general purpose computer system or a dedicated machine), firmware, or a combination. In one embodiment, the method 300 is performed by a media device (such as media device 210 in FIG. 2).

Referring to FIG. 3, processing logic begins by initiating biometric data capture in response to at least playback of media data on a first device (processing block 302). In one embodiment, the capture of biometric data may be initiated by processing logic each time media data is played on the first device. In one embodiment, the capture of biometric data is initiated when one or more other conditions for biometric capture occur during playback of the media data. For example, before or during playback of the media data, processing logic may detect motion data indicative of the phone being transferred between users, audio data indicative of a command to transfer the media data, audio data indicative of an inferred request to transfer the media data, etc.

Processing logic then captures one or more forms of biometric data of a user that is consuming the media data (processing block 304). In one embodiment, the captured biometric data may include image(s) of the user's face captured by a camera where the user is in the camera's field of view, finger print scanning data captured by a finger print scanner mounted on a device, grip detection data that is based on grip size, pressure, spacing etc. of a user holding a media device, iris scans, as well as other types of biometric data. In one embodiment, other forms of user identification data, such as non-biometric user identification can be collected by processing logic. Furthermore, biometric and other forms of user identification data may be collected from multiple users and the content sharing performed as discussed herein for each user in parallel.

Processing logic extracts one or more features from the captured biometric data (processing block 306), and compares the extracted features with biometric features associated with a known authorized user of the first device (processing block 308). For example, facial features extracted from image data are used by processing logic to generate a biometric template. The biometric template can be compared with one or more templates associated with authorized users. In one embodiment, the images and/or biometric templates for the authorized users of a device are stored on the device prior to the matching discussed herein. As another example, a grip profile may be extracted from pressure sensor data of the first device for a user who is holding the first device. The generated grip profile may be based on such factors as grip pattern, size, strength, etc., and compared with grip profiles of authorized users of the first device. In one embodiment, multiple forms of biometric data may be used at the same time to determine a match with an authorized user of the first device, and in order to improve the accuracy of the match.

Processing logic determines whether there is a match between the captured biometric data and authorized user biometric data (decision block 310). When there is a match at decision block 310, processing logic determines that the user consuming the content is an authorized user of the first device (processing block 312). Since the user is determined to be an authorized user, the media data need not be shared and the process ends. However, when there is a biometric mismatch at decision block 310, processing logic initiates sharing of the media data based on the captured biometric data (processing block 314), as discussed in greater detail below.

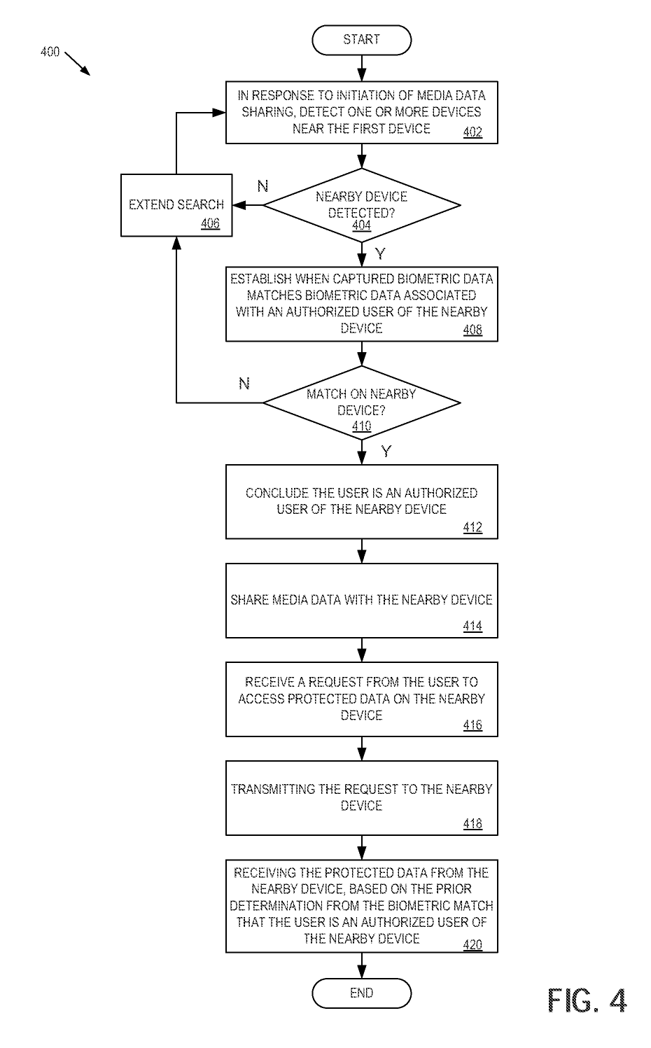

FIG. 4 is a flow diagram of one embodiment of a method 400 for locating a device based on user biometric data and exchanging content with the located device. The method 400 is performed by processing logic that may comprise hardware (circuitry, dedicated logic, etc.), software (such as is run on a general purpose computer system or a dedicated machine), firmware, or a combination (none of which are illustrated in FIG. 4). In one embodiment, the method 400 is performed by a media device (such as media device 210 in FIG. 2).

Referring to FIG. 4, processing logic begins by detecting one or more devices near the first device, in response to the initiation of media data sharing (processing block 402). As discussed above, processing logic may detect devices connected to the same WiFi network, which are within a specified geography and/or network location relative to the first device. Processing logic may also detect devises that are in range of a personal area network established by processing logic. When there are no nearby devices detected (decision block 404), processing logic can extend the search to locate additional devices (processing block 406). In one embodiment, where a distance or geographic restriction is imposed on the search performed in block 402, the distance or geographic restriction may be expanded. Furthermore, if processing logic first attempts to locate devices within range of a personal area network, and none are found, processing logic can extend the search to include a WiFi or wired network.

When a nearby device is found at decision block 404, processing logic establishes when captured biometric data matches biometric data associated with an authorized user of the nearby device (processing block 408). In one embodiment, because there was a biometric mismatch at the first device, processing logic attempts to locate nearby, or collocated devices, where there is a biometric match. In one embodiment, a biometric matching process may be performed by the nearby devices on the captured biometric data, as discussed above. When no match is found with the nearby devices (decision block 410), processing logic extends the search for additional devices (processing block 406).

However, when there is a match on a nearby device at decision block 410, processing logic concludes that the user consuming media on the first device is an authorized user of the nearby device (processing block 412). After this determination, processing logic shares the media data with the nearby device (processing block 414). The media data itself may share shared with the nearby device, as well as links or instructions that enable the nearby device to access the media data.

In one embodiment, processing logic receives a request from the user to access protected data on the nearby device (processing block 416). Although receipt of the user request is illustrated as occurring after the sharing of the media data, in one embodiment, the request to access protected content can occur any time after the match is found with the nearby device. That is, once the user is determined to be an authorized user of the nearby device, the content sharing and the protected content access can occur in any order, as well as concurrently. Processing logic transmits the request for the protected content to the nearby device (processing block 418), and receives the protected content from the nearby device (processing block 420). In one embodiment, processing logic is able to access the protected content but the user's access credentials are not shared with the first device.

In one embodiment, it may be desirable to utilize the services of a verification server for determining when nearby devices are associated with media data consumers, as well as to exchange content between nearby devices. For example, the verification server may be a trusted third party server, which is used as an intermediary between devise to avoid transmitting biometric data to unknown, nearby devices. Furthermore, use of the verification server limits a first, media playback device from associating identified devices with user biometric data.

FIG. 5 is a flow diagram of one embodiment of a method 500 for utilizing a verification server for exchanging content between devices based on user biometric data. The method 500 is performed by processing logic that may comprise hardware (circuitry, dedicated logic, etc.), software (such as is run on a general purpose computer system or a dedicated machine), firmware, or a combination (none of which are shown in FIG. 5). In one embodiment, the method 500 is performed by a media device (such as media device 210 in FIG. 2) and a verification server (such as verification server 280 in FIG. 2).

Referring to FIG. 5, processing logic of the verification server begins by receiving biometric data from a user of a second device to register the user, and the user's device, with the verification server (processing block 502). In the embodiments discussed in FIG. 5, users pre-register their devices and provide the verification server with one or more forms of biometric identification data. In one embodiment, the exchange of the biometric data with the verification server during registration of a user and/or device is in encrypted form.

Processing logic of the media playback device then captures biometric data of a user at a first device (processing block 504). In one embodiment, the capture of user biometric data occurs in accordance with the discussion of FIGS. 1 and 3, discussed above. The captured biometric data is then sent to the verification server (processing block 506). In one embodiment, the captured biometric data is also sent to the server in encrypted form. Therefore, in one embodiment, the exchange of sensitive data with the verification server is secure in all exchanges.

Processing logic of the verification server compares the received biometric data with biometric data of the users registered with the verification server (processing block 508). When a match is found (decision block 510), processing logic enables media and protected content sharing between the first and second devises (processing block 512). In one embodiment, the media and protected content sharing is enabled by the verification server providing the first device with an identifier associated with the second device, which enables the first and second devices to communicatively couple with one another. In another embodiment, the media and protected content sharing is enabled by the verification server acting as an intermediary for communication, including the sharing of content, between the first device and the second device.

When no match is found at decision block 510, processing logic of the media playback device receives notification that there are no available devices for pairing (processing block 514), and the process ends.

FIG. 6 is one embodiment of a system that may be used as a verification server or a user device. It will be apparent to those of ordinary skill in the art, however that other alternative systems of various system architectures may also be used.

The system illustrated in FIG. 6 includes a bus or other internal communication means 615 for communicating information, and a processor 610 coupled to the bus 615 for processing information. The system further comprises a random access memory (RAM) or other volatile storage device 650 (referred to as memory), coupled to bus 615 for storing information and instructions to be executed by processor 610. Main memory 650 also may be used for storing temporary variables or other intermediate information during execution of instructions by processor 610. The system also comprises a read only memory (ROM) and/or static storage device 620 coupled to bus 615 for storing static information and instructions for processor 610, and a data storage device 625 such as a magnetic disk or optical disk and its corresponding disk drive. Data storage device 625 is coupled to bus 615 for storing information and instructions.

The system may further be coupled to a display device 670, such as a light emitting diode (LED), a liquid crystal display (LCD), interferometric modulator display (IMOD), etc., coupled to bus 615 through bus 665 for displaying information to a user. An alphanumeric input device 675, including alphanumeric and other keys, may also be coupled to bus 615 through bus 665 for communicating information and command selections to processor 610. An additional user input device is cursor control device 680, such as a touchpad, mouse, a trackball, stylus, or cursor direction keys coupled to bus 615 through bus 665 for communicating direction information and command selections to processor 610.

Another device, which may optionally be coupled to system 600, is a communication device 690 for accessing other nodes of a distributed system via a network. The communication device 690 may include any of a number of commercially available networking peripheral devices such as those used for coupling to an Ethernet, token ring, Internet, or wide area network. The communication device 690 may further be a null-modem connection, or any other mechanism that provides connectivity between the system 600 and the outside world. Note that any or all of the components of this system illustrated in FIG. 6 and associated hardware may be used in various embodiments.

It will be appreciated by those of ordinary skill in the art that any configuration of the system may be used for various purposes according to the particular implementation. The control logic or software implementing the systems and methods discussed herein can be stored in main memory 650, mass storage device 625, or other storage medium locally or remotely accessible to processor 610.

It will be apparent to those of ordinary skill in the art that the system, method, and process described herein can be implemented as software stored in main memory 650 or read only memory 620 and executed by processor 610. This control logic or software may also be resident on an article of manufacture comprising a non-transitory computer readable medium having computer readable program code embodied therein and being readable by the mass storage device 625 and for causing the processor 610 to operate in accordance with the methods and teachings herein.

The systems and methods discussed herein may also be embodied in a handheld, portable, or multimedia presentation device containing a subset of the hardware components described above. For example, a handheld device may be configured to contain only the bus 615, the processor 610, and memory 650 and/or 625. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation for such a device would be apparent to one of ordinary skill in the art given the disclosure of the systems and methods as provided herein.

The systems and methods discussed herein may also be embodied in a special purpose appliance, such as a television or camera, including a subset of the computer hardware components described above. For example, the appliance may include a processor 610, a data storage device 625, a bus 615, and memory 650, and only rudimentary communications mechanisms, such as a small touch-screen or remote control that permits the user to communicate in a basic manner with the device. In general, the more special-purpose the device is, the fewer of the elements need be present for the device to function.

FIG. 7 is block diagram of one embodiment 700 of a mobile device. Mobile device 710 provides additional details, which may be utilized for the media device 210 and/or user device 250 discussed above in FIG. 2.

In one embodiment, mobile device 710 is a system, which may include one or more processors 712, a memory 705, I/O controller 725, network interface 704, and display 720. Mobile device 710 may also include a number of processing modules, which may be implemented as hardware, software, firmware, or a combination. It should be appreciated that mobile device 710 may also include, although not illustrated, a user interface (e.g., keyboard, touch-screen, or similar devices), a power device (e.g., a battery), as well as other components typically associated with electronic devices. Network interface 704 may also be coupled to a number of wireless subsystems 715 (e.g., Bluetooth, Wi-Fi, Cellular, or other networks) to transmit and receive data streams through a wireless link to/from a network, or may be a wired interface for direct connection to networks (e.g., the Internet, Ethernet, or other wireless systems). In one embodiment, both network interface 704 and wireless subsystem 715 couple mobile device 710 to a network.

Memory 705 may be coupled to processor 712 to store instructions for execution by processor 712. In some embodiments, memory 705 is non-transitory. It should be appreciated that embodiments as described herein may be implemented through the execution of instructions, for example as stored in the memory 705 or other element, by processor 712 of mobile device 710 and/or other circuitry of mobile device 710 and/or other devices. Particularly, circuitry of mobile device 710, including but not limited to processor 712, may operate under the control of a program, routine, or the execution of instructions to execute methods or processes in accordance with the discussion herein. For example, such a program may be implemented in firmware or software (e.g. stored in memory 705 and/or other locations) and may be implemented by processors, such as processor 712, and/or other circuitry of mobile device 710. Further, it should be appreciated that the terms processor, microprocessor, circuitry, controller, etc., may refer to any type of logic or circuitry capable of executing logic, commands, instructions, software, firmware, functionality and the like.

Further, it should be appreciated that some or all of the functions, engines or modules described herein may be performed by mobile device 710 itself and/or some or all of the functions, engines or modules described herein may be performed by another system connected through I/O controller 725 or network interface 704 (wirelessly or wired) to mobile device 710. Thus, some and/or all of the functions may be performed by another system and the results or intermediate calculations may be transferred back to mobile device 710. In some embodiments, such other device may comprise a server, such as verification server 280 configured to process information in real time or near real time. In some embodiments, the other device is configured to predetermine the results, for example based on a known configuration of the mobile device 710.

It is to be understood that the above description is intended to be illustrative, and not restrictive. Many other embodiments will be apparent to those of skill in the art upon reading and understanding the above description. The scope of the embodiments should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the systems and methods discussed herein and their practical applications, to thereby enable others skilled in the art to best utilize the various embodiments with various modifications as may be suited to the particular use contemplated.

It should be appreciated that when the devices discussed herein is a mobile or wireless device, that it may communicate via one or more wireless communication links through a wireless network that are based on or otherwise support any suitable wireless communication technology. For example, in some aspects computing device or server may associate with a network including a wireless network. In some aspects the network may comprise a body area network or a personal area network (such as an ultra-wideband network). In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A mobile wireless device may wirelessly communicate with other mobile devices, cell phones, other wired and wireless computers, Internet web-sites, etc.

The teachings herein may be incorporated into (for example, implemented within or performed by) a variety of apparatuses or devices. For example, one or more aspects taught herein may be incorporated into a phone (such as a cellular phone), a personal data assistant (PDA), a tablet, a mobile computer, a laptop computer, an entertainment device (e.g., a music or video device), a gaming device such as a handheld gaming console, a headset (e.g., headphones, an earpiece, etc.), a medical device (e.g., a biometric sensor, a heart rate monitor, a pedometer, an Electrocardiography (EKG) device, etc.), a user I/O device, a computer, a server, a point-of-sale device, a set-top box, a smartwatch, a head-mounted display device, or any other suitable device. These devices may have different power and data requirements and may result in different power profiles generated for each feature or set of features.

In some aspects a wireless device may comprise an access device (for example, a Wi-Fi access point) for a communication system. Such an access device may provide, for example, connectivity to another network (e.g., a wide area network such as the Internet or a cellular network) via a wired or wireless communication link. Accordingly, the access device may enable another device (for example, a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present discussion.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the described methods and systems. Thus, the present embodiments are not intended to be limited to the embodiments shown herein but are to be accorded the widest scope consistent with the principles and novel features disclosed herein.

What is claimed is:

1. A method comprising:
initiating, in a first device, biometric data capture of a user based, at least in part, on playback of media data by the first device;
determining that captured biometric data of the user does not correspond with biometric data associated with an authorized user of the first device;
in response to a failure to match the captured biometric data by the first device, establishing that the user is an authorized user of a second device based, at least in part, on the captured biometric data; and
sharing the media data with the second device.

2. The method of claim 1, wherein establishing that the user is the authorized user of the second device further comprises:
detecting that the second device is near the first device;
sending an authentication request, based at least in part on the captured biometric data of the user, from the first device to the second device;
receiving an authentication response from the second device indicating the user is the authorized user of the second device.

3. The method of claim 2, wherein the second device is detected near the first device when the first device and the second device are proximately located and on the same wireless network.

4. The method of claim 2, wherein the second device is detected near the first device when the second device is within range of a personal area network generated by the first device.

5. The method of claim 2, wherein the second device is detected near the first device when the second device is within predetermined geofenced boundary relative to the first device.

6. The method of claim 1, wherein the biometric data captured by the first device comprises one or more of facial recognition biometric data, fingerprint scan biometric data, grip pattern biometric data, iris biometric data, voice recognition biometric data, sclera biometric data, electrocardiogram pattern data, vascular pattern data, and touch pattern data.

7. The method of claim 1, further comprising:
sending a request for protected content to the second device after establishing that the user is the authorized user of the second device;
receiving the requested protected content; and
rendering the protected content to the user on the first device.

8. The method of claim 1, wherein establishing that the user is the authorized user of the second device, further comprises:
sending the captured biometric data to a verification server;
receiving a notification from the verification server that the captured biometric data matches registered biometric data on the verification server, wherein the notification comprises an identification of the second device; and
in response to the notification from the verification server, sharing the media data with the second device.

9. The method of claim 8, further comprising:
sending the media data to one or both of the verification server and the second device.

10. The method of claim 1, further comprising:
collecting sensor data with a sensor of the first device, the sensor data indicative of a movement of the first device;
determining from the sensor data that a type of movement of the first device corresponds with a physical transfer of the device to the user from a different user; and
based on the determined type of movement, initiating the biometric data capture of the user.

11. The method of claim 1, wherein initiating biometric data capture, further comprises:
initiating biometric data capture of a plurality of users over a period of time;
detecting one or more devices near the first device;
establishing that at least one user from the plurality of users is an authorized user of a third device based, at least in part, on the captured biometric data corresponding to the at least one user; and
establishing, with the first device, an ad hoc network between the first, second, and third devices, wherein the media data is shared between the first, second, and third devices utilizing the ad hoc network.

12. The method of claim 11, further comprising:
limiting an existence of the ad hoc network based on one or both of a maximum time the ad hoc network can be active and a maximum distance between of the first, second, and third devices on the ad hoc network.

13. The method of claim 1, wherein the first device receives an authentication result determined by the second device to established the user as the authorized user of the second device.

14. A non-transitory computer readable storage medium including instructions that, when executed by a processor, cause the processor to perform a method for authenticating a user on a mobile device, the method comprising:
Initiating, in a first device biometric data capture of a user based, at least in part, on playback of media data by the first device;
determining that captured biometric data of the user does not correspond with biometric data associated with an authorized user of the first device;
in response to a failure to match the captured biometric data by the first device, establishing that the user is an authorized user of a second device based, at least in part, on the captured biometric data; and
sharing the media data with the second device.

15. The non-transitory computer readable storage medium of claim 14, wherein establishing that the user is the authorized user of the second device further comprises:
detecting that the second device is near the first device;
sending an authentication request, based at least in part on the captured biometric data of the user, from the first device to the second device;
receiving an authentication response from the second device indicating that the user is the authorized user of the second device.

16. The non-transitory computer readable storage medium of claim 14, wherein the second device is detected near the first device when the first device and the second device are proximately located and on the same wireless network.

17. The non-transitory computer readable storage medium of claim 14, wherein the second device is detected near the first device when the second device is within range of a personal area network generated by the first device.

18. The non-transitory computer readable storage medium of claim 14, wherein the second device is detected near the first device when the second device is within predetermined geofenced boundary relative to the first device.

19. The non-transitory computer readable storage medium of claim 14, wherein the biometric data captured by the first device comprises one or more of facial recognition biometric data, fingerprint scan biometric data, grip pattern biometric data, iris biometric data, voice recognition biometric data, sclera biometric data, electrocardiogram pattern data, vascular pattern data, and touch pattern data.

20. The non-transitory computer readable storage medium of claim 14, further comprising:
sending a request for protected content after establishing that the user is the authorized user of the second device;
receiving the requested protected content; and
rendering the protected content to the user on the first device.

21. The non-transitory computer readable storage medium of claim 14, wherein establishing that the user is the authorized user of the second device, further comprises:
sending the captured biometric data to a verification server;
receiving a notification from the verification server that the captured biometric data matches registered biometric data on the verification server, wherein the notification comprises an identification of the second device; and
in response to the notification from the verification server, sharing the media data with the second device.

22. The non-transitory computer readable storage medium of claim 21, further comprising:
sending the media data to one or both of the verification server and the second device.

23. The non-transitory computer readable storage medium of claim 14, further comprising:
collecting sensor data with a sensor of the first device, the sensor data indicative of a movement of the first device;
determining from the sensor data that a type of movement of the first device corresponds with a physical transfer of the device to the user from a different user; and
based on the determined type of movement, initiating the biometric data capture of the user.

24. The non-transitory computer readable storage medium of claim 14, wherein initiating biometric data capture, further comprises:
initiating biometric data capture of a plurality of users over a period of time;
detecting one or more devices near the first device;
establishing that at least one user from the plurality of users is an authorized user of a third device based, at least in part, on the captured biometric data corresponding to the at least one user; and
establishing, with the first device, an ad hoc network between the first, second, and third devices, wherein the media data is shared between the first, second, and third devices utilizing the ad hoc network.

25. The non-transitory computer readable storage medium of claim 24, further comprising:
limiting an existence of the ad hoc network based on one or both of a maximum time the ad hoc network can be active and a maximum distance between of the first, second, and third devices on the ad hoc network.

26. The non-transitory computer readable storage medium of claim 14, wherein the first device receives an authentication result determined by the second device to established the user as the authorized user of the second device.

27. A system for sharing media data, comprising:
a memory to store biometric data associated with one or more authorized users of a first device; and
a processor coupled with the memory configured to
initiate, in a first device, biometric data capture of a user based, at least in part, on playback of media data by the first device,
determine that captured biometric data of the user does not correspond with biometric data stored in the memory,
in response to a failure to match the captured biometric data by the first device, establish that the user is an authorized user of a second device based, at least in part, on the captured biometric data, and
share the media data with the second device.

28. The system of claim 27, wherein the processor configured to establish that the user is the authorized user of the second device further comprises the processor configured to
detect that the second device is near the first device,
send an authentication request, based at least in part on the captured biometric data of the user, from the first device to the second device, and
receive an authentication response from the second device indicating that the user is the authorized user of the second device.

29. The system of claim 27, further comprising the processor configured to
send a request for protected content to the second device after establishing that the user is the authorized user of the second device, receive the requested protected content, and
render the protected content to the user on the first device.

30. A system for sharing media data, comprising:
means for initiating, in a first device, biometric data capture of a user based, at least in part, on playback of media data by the first device;
means for determining that captured biometric data of the user does not correspond with biometric data associated with an authorized user of the first device;
in response to a failure to match the captured biometric data by the first device, means for establishing that the user is an authorized user of a second device based, at least in part, on the captured biometric data; and
means for sharing the media data with the second device.
